(19) United States
(12) Patent Application Publication
(10) Pub. No.: US 2024/0222688 A1
(43) Pub. Date: Jul. 4, 2024

(54) METHOD FOR CONTROLLING LITHIUM SECONDARY BATTERY

(71) Applicant: HONDA MOTOR CO., LTD., Tokyo (JP)

(72) Inventors: Tomohiro KINOSHITA, Saitama (JP); Wataru SHIMIZU, Saitama (JP); Wataru HOSHIKAWA, Saitama (JP)

(21) Appl. No.: 18/393,694

(22) Filed: Dec. 22, 2023

(30) Foreign Application Priority Data
Dec. 28, 2022 (JP) 2022-211502

(51) Int. Cl. H01M 10/0525; H02J 7/00

(52) U.S. Cl. CPC H01M 10/0525; H02J 7/007188

(57) ABSTRACT

It is an object of the present disclosure to provide a method for controlling a lithium secondary battery capable of more safely eliminating a dendrite deposition state. To achieve the object, the present disclosure provides a method for controlling a lithium secondary battery. The method includes detecting presence or absence of dendrite deposition on a negative electrode of the lithium secondary battery, performing high-rate discharge by a discharge controller for controlling a discharge amount of the lithium secondary battery when the dendrite deposition is detected, and increasing a restraint pressure of the lithium secondary battery by a restraint pressure controller for controlling the restraint pressure of the lithium secondary battery after performing the high-rate discharge.

This application is based on and claims the benefit of priority from Japanese Patent Application No. 2022-211502, filed on 28 Dec. 2022, the content of which is incorporated herein by reference.

### BACKGROUND OF THE INVENTION

### Field of the Invention

The present invention relates to a method for controlling a lithium secondary battery.

### Related Art

In recent years, research and development have been conducted on secondary batteries that contribute to energy efficiency in order to ensure that more people have access to affordable, reliable, sustainable, and advanced energy.

Lithium ion secondary batteries having high voltage, capacity, and energy density have been widely used as secondary batteries. In recent years, as a lithium secondary battery having a larger theoretical capacity, a lithium metal battery including a lithium metal, an alloy thereof, or the like in a negative electrode is known. As an issue of these lithium secondary batteries, there is a point that lithium metal is deposited in a dendritic manner on the negative electrode during charging and discharging cycles. The deposited lithium metal is also called dendrite, and there is a possibility that a short circuit occurs when the dendrite grows and comes into contact with the positive electrode.

Patent Document 1 discloses, as a controller for a lithium ion secondary battery, the following technology: when it is determined that lithium has been deposited, a recoverable time during which the deposited lithium can be recovered is estimated, and when the recoverable time is reached, a charging current flowing through the secondary battery is limited to a reference value or less, and a restraint pressure of the secondary battery is increased, and thereby inactive portions are broken and the decrease in the battery capacity of the secondary battery is suppressed.
Patent Document 1: Japanese Unexamined Patent Application, Publication No. 2021-034264

### SUMMARY OF THE INVENTION

Since the technology disclosed in Patent Document 1 increases the restraint pressure of the secondary battery after the recoverable time has elapsed when it is determined that lithium has been deposited, if the restraint pressure of the secondary battery is increased in a state in which dendrite deposition progresses, the dendrites may break through the separator, resulting in a short circuit.

In response to the above issue, an object of the present invention is to provide a method for controlling a lithium secondary battery that can more safely eliminating a dendrite deposition state.

(1) A first aspect of the present invention relates to a method for controlling a lithium secondary battery. The method includes detecting presence or absence of dendrite deposition on a negative electrode of the lithium secondary battery, performing high-rate discharge by a discharge controller for controlling a discharge amount of the lithium secondary battery when the dendrite deposition is detected, and increasing a restraint pressure of the lithium secondary battery by a restraint pressure controller for controlling the restraint pressure of the lithium secondary battery after performing the high-rate discharge.

According to the invention of the first aspect, it is possible to provide the method for controlling a lithium secondary battery capable of more safely eliminating a dendrite deposition state.

(2) In a second aspect of the present invention according to the first aspect, a discharge rate of the high-rate discharge performed by the discharge controller when the dendrite deposition is detected is 1.0 C or more.

According to the invention of the second aspect, safety in increasing the restraint pressure can be further improved.

(3) In a third aspect of the present invention according to the first or second aspect, the restraint pressure of the lithium secondary battery after being increased by the restraint pressure controller is 1.3 MPa or more.

According to the invention of the third aspect, the dendrite deposition state can be reliably eliminated.

(4) In a fourth aspect of the present invention according to any one of the first to third aspects, the negative electrode of the lithium secondary battery includes a lithium metal layer.

According to the invention of the fourth aspect, it is possible to safely eliminate the dendrite deposition state of the lithium secondary battery including the lithium metal layer in which dendrites are more likely to be deposited.

### BRIEF DESCRIPTION OF THE DRAWINGS

FIG. 1 is a flowchart showing a method for controlling a lithium secondary battery according to the present embodiment;

FIG. 2 is a conceptual sectional view showing a configuration of a lithium secondary battery cell according to the present embodiment;

FIG. 3 is a conceptual sectional view showing a configuration of a secondary battery module including a plurality of the lithium secondary battery cells according to the present embodiment; and

FIG. 4 is a graph schematically showing a relationship between a restraint pressure for a secondary battery, a deposition thickness, and a porosity.

### DETAILED DESCRIPTION OF THE INVENTION

### <Overview of Method for Controlling Lithium Secondary Battery>

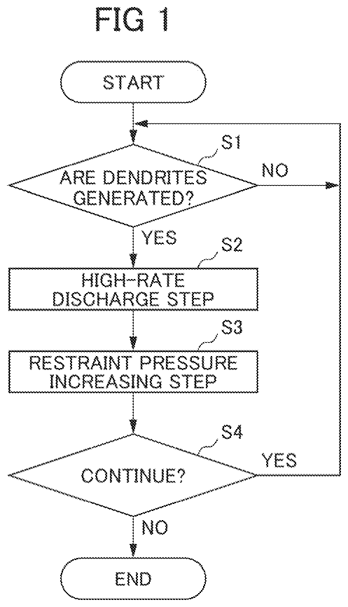

The method for controlling a lithium secondary battery according to the present embodiment more safely eliminates the dendrite deposition state when the generation of dendrite on the negative electrode of the lithium secondary battery is detected. The method for controlling a lithium secondary battery according to the present embodiment includes a dendrite detection step S1, a high-rate discharge step S2, and a restraint pressure increasing step S3 shown in FIG. 1.

The target of the method for controlling a lithium secondary battery according to the present embodiment may be a lithium ion secondary battery or a lithium metal battery including a metallic lithium layer in the negative electrode. It is preferable to apply the method for controlling a lithium secondary battery according to the present embodiment to a lithium metal battery in which dendrite deposition tends to occur in the negative electrode.

### <Lithium Secondary Battery>

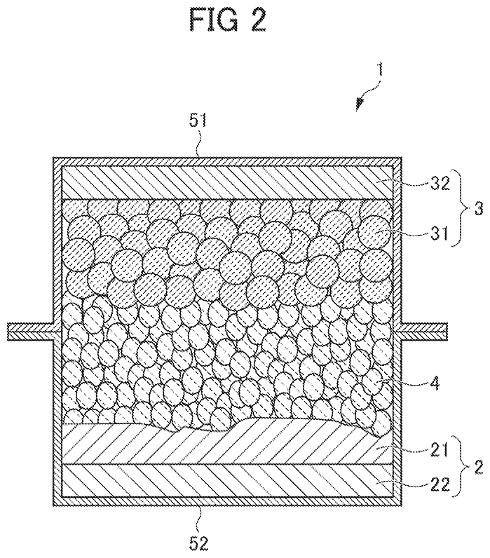

FIG. 2 is a sectional view showing an outline of a lithium secondary battery which is the target of the method for controlling a lithium secondary battery according to the present embodiment. As shown in FIG. 2, a battery cell 1 of the lithium secondary battery includes a negative electrode 2 including a negative electrode active material layer 21 and a negative electrode current collector 22, a positive electrode 3 including a positive electrode active material layer 31 and a positive electrode current collector 32, an electrolyte layer 4 stacked between the negative electrode 2 and the positive electrode 3, and exterior bodies 51 and 52 that house the negative electrode 2, the electrolyte layer 4, and the positive electrode 3.

### (Negative Electrode)

The negative electrode 2 includes, for example, the negative electrode current collector 22 and the negative electrode active material layer 21 stacked adjacent to the negative electrode current collector 22. In addition to the above, the negative electrode 2 may include a binder, a conductivity aid, an electrolyte, and the like. The binder, the conductivity aid, the electrolyte, and the like are not limited, and substances known as electrode materials for secondary batteries can be applied.

When the lithium secondary battery is a lithium metal battery, the negative electrode active material layer 21 essentially includes a lithium metal layer. The lithium metal layer may be a layer of simple lithium metal or a layer of a lithium metal alloy. The material constituting the lithium alloy together with the lithium metal is not limited, and examples thereof include tin, bismuth, antimony, zinc, and copper, and two or more types thereof may be used in combination.

When the lithium secondary battery is a lithium ion secondary battery, the negative electrode active material layer 21 includes a negative electrode active material.

The negative electrode active material is not limited as long as it can occlude and release lithium ions. Examples of the negative electrode active material include metal lithium, a lithium alloy, a metal oxide, a metal sulfide, a metal nitride, Si, Sio, and a carbon material. Examples of the carbon material include artificial graphite, natural graphite, hard carbon, and soft carbon.

The negative electrode current collector 22 is not limited, and examples thereof include metals such as copper, stainless steel, and aluminum. The metal is formed in a foil shape, for example.

### (Positive Electrode)

The positive electrode 3 includes, for example, the positive electrode current collector 32, and the positive electrode active material layer 31 stacked adjacent to the positive electrode current collector 32. In addition to the above, the positive electrode 3 may include a binder, a conductivity aid, an electrolyte, and the like. The binder, the conductivity aid, the electrolyte, and the like are not limited, and substances known as electrode materials for secondary batteries can be applied.

The positive electrode active material included in the positive electrode active material layer 31 is not limited, and any material known as a positive electrode active material of a lithium secondary battery can be used. Examples of the positive electrode active material include ternary positive electrode materials such as LiCoO₂, LiNiO₂, and NCM (Li(NiₓCo_{y}Mn_{z}) O₂, (0<x<1, 0<y<1, 0<z<1, x+y+z=1)), layered positive electrode active material particles such as LiVO₂ and LiCrO₂, spinel positive electrode active materials such as LiMn₂O₄, Li(Ni_{0.25}Mn_{0.75})₂O₄, LiCoMnO₄, and Li₂NiMn₃O₈, and olivine positive electrode active materials such as LiCoPO₄, LiMnPO₄, and LiFePO₄.

The positive electrode current collector 32 is not limited, and examples thereof include metals such as aluminum. The metal is formed in a foil shape, for example.

### (Electrolyte Layer)

The electrolyte layer 4 includes an electrolytic solution in which an electrolyte is dissolved in a solvent. The electrolyte layer 4 may include a separator for preventing short circuits between the positive electrode 3 and the negative electrode 2, and preferably includes a separator, especially when the lithium secondary battery is a lithium ion secondary battery. The separator may be impregnated with the electrolytic solution. As the separator, a material known as a separator for a lithium secondary battery, such as a nonwoven fabric or a microporous film, can be used.

The electrolytic solution may be gelled with a gellant. Examples of the gellant include, but are not limited to, a PEO (polyethylene oxide) gellant, a PPO (polypropylene oxide) gellant, a PAN (polyacrylonitrile) gellant, a PVC (polyvinyl chloride) gellant, PVdF (polyvinylidene fluoride) gellant, a PMMA (polymethyl methacrylate) gellant, and a PVdF-HEP (vinylidene fluoride-hexafluoropropylene copolymer) gellant, a PDMS (polydimethylsiloxane) gellant, and a low-molecular gellant utilizing I-n stacking.

Examples of the electrolyte include, but are not limited to, lithium bis (fluorosulfonyl) imide (LiFSI), lithium hexafluorophosphate, lithium hexafluoroborate, and lithium bis (trifluoromethanesulfonyl) imide, and two or more types thereof may be used in combination.

The solvent is not limited, and examples thereof include ethylene carbonate, propylene carbonate, dimethyl ether, fluoroethylene carbonate, dimethyl carbonate, hydrofluoro ether, ethylmethyl carbonate, and diethyl carbonate. The above solvents may be used alone or in a combination of two or more.

### (Exterior Bodies)

The exterior bodies 51 and 52 house the stacked negative electrode 2, electrolyte layer 4, and positive electrode 3. As shown in FIG. 2, for example, a pair of laminated films can be used as the exterior bodies 51 and 52. The feature of the exterior bodies is not limited to the above, and known exterior bodies applied to a secondary battery can be used.

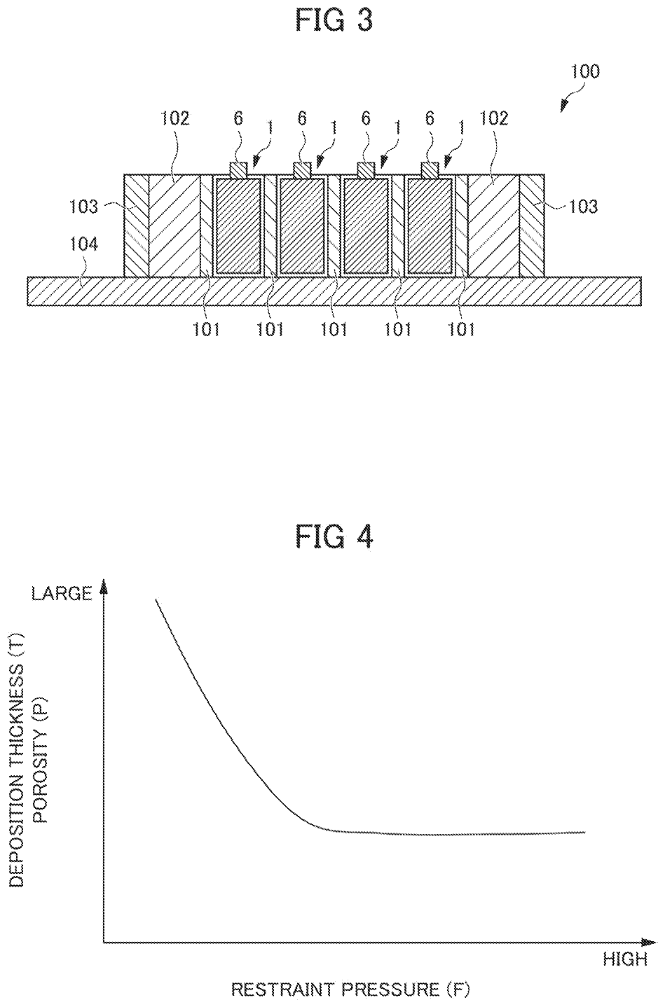

In addition to the above, the battery cell 1 includes an electrode tab 6 shown in FIG. 3. The electrode tab 6 is electrically connected to the negative electrode 2 and/or the positive electrode 3. The electrode tab 6 is electrically connected to a discharge target (not shown). The battery cell 1 is subjected to high-rate discharge, which will be described later, via a discharge controller.

### <Lithium Secondary Battery Module>

The target of the method for controlling a lithium secondary battery according to the present embodiment may be a lithium secondary battery module 100 including a plurality of the battery cells 1. As shown in FIG. 3, the lithium secondary battery module 100 includes a plurality of the battery cells 1, separators 101 each disposed between adjacent battery cells 1, end plates 102 disposed at both ends of the plurality of stacked battery cells 1 and separator 101, binding bars 103, and a lower plate 104.

The separator 101 ensures insulation between the adjacent battery cells 1 and applies uniform surface pressure to the battery cells 1. The end plates 102 apply a restraint pressure to the plurality of battery cells 1. For example, a restraint pressure controller for controlling the restraint pressure applied to the plurality of battery cells 1 by the end plates 102 executes the restraint pressure increasing step S3, which will be described later. The binding bar 103 enhances the binding property of the plurality of stacked battery cells 1 and separators 101. The lower plate 104 fixes the plurality of stacked battery cells 1 and separators 101.

In addition to the above, the lithium secondary battery module 100 may include a current sensor or the like capable of detecting a current value during charging and discharging. The above is an example of the configuration of the lithium secondary battery module, and the configuration of the lithium secondary battery module is not limited to the above. The target of the method for controlling a lithium secondary battery according to the present embodiment is not limited to the above configuration, and it is only required that the restraint pressure and the discharge current for the battery cells 1 can be controlled.

### <Method for Controlling Lithium Secondary Battery>

The method for controlling a lithium secondary battery according to the present embodiment essentially includes a dendrite detection step S1, a high-rate discharge step S2, and a restraint pressure increasing step S3 shown in FIG. 1.

### (Dendrite Detection Step S1)

The dendrite detection step S1 is a step of detecting the presence or absence of dendrite deposition on the negative electrode 2. The determination of the presence or absence of dendrite deposition is made, for example, based on the current value and the energization time in the charging of the battery cell 1. The current value is obtained, for example, by a current sensor included in the battery cell 1 or the battery module 100. When dendrite deposition is detected in the dendrite detection step S1, the processing advances to the high-rate discharge step S2. When dendrite deposition is not detected in the dendrite detection step S1, the dendrite detection step S1 is repeated until dendrite deposition is detected.

### (High-Rate Discharge Step S2)

The high-rate discharge step S2 is a step of performing high-rate discharge of the battery cell 1 when dendrite deposition is detected in the dendrite detection step S1. By performing high-rate discharge on the battery cell 1 with dendrites deposited, lithium metal is preferentially dissolved from the tips of dendrites (lithium metal) deposited in a dendritic manner. This reduces the risk that the tips of the dendrites break the separator or the like to cause a short circuit in the restraint pressure increasing step S3 to be executed later, so that the dendrite deposition state can be safely eliminated. The discharge rate in the high-rate discharge step S2 is preferably 1.0 C or more. By setting the discharge rate to 1.0 C or more, a large concentration gradient is generated on the lithium surface, thereby increasing the current density at the tips of dendrites (lithium metal) deposited in a dendritic manner. As a result, the tips of the dendrites (lithium metal) are preferentially dissolved. This enables non-uniform lithium deposits to be removed and a uniform surface to be obtained after discharge. The high-rate discharge is executed, for example, by a discharge controller for controlling the amount of discharge from the battery cell 1.

### (Restraint Pressure Increasing Step S3)

The restraint pressure increasing step S3 is executed after the high-rate discharge step S2. In the restraint pressure increasing step S3, the restraint pressure for the lithium secondary battery is increased to crush dendritic porous dendrites and improve the density. FIG. 4 is a graph schematically showing the relationship between the restraint pressure (F) applied to the lithium secondary battery and the dendrite deposition thickness (T) and porosity (P). FIG. 4 shows that the dendrite deposition thickness (T) and porosity (P) decrease as the restraint pressure increases. In view of the above, the restraint pressure of the lithium secondary battery before the increase in the restraint pressure increasing step S3 is preferably 0.5 to 1.2 MPa, whereas the restraint pressure of the lithium secondary battery after the increase is preferably 1.3 MPa or more.

The restraint pressure increasing step S3 is executed by a restraint pressure controller for controlling the restraint pressure of the lithium secondary battery. As a specific configuration of the restraint pressure controller, for example, a restraint pressure controller including a pressure sensor capable of detecting the restraint pressure of the battery cells 1, a connecting member (for example, a bolt and a nut) connecting the pair of end plates 102 of the battery module 100, and a control unit capable of controlling the restraint pressure of the battery cells 1 by the connecting member is exemplified. The restraint pressure controller controls the restraint pressure of the battery cells 1 by controlling, for example, the amount of fastening of the battery cells 1 by the connecting member.

The method for controlling a lithium secondary battery according to the present embodiment includes a determination step S4 of determining whether to continue to execute this control after the restraint pressure increasing step S3. When it is determined in the determination step S4 that this control is to be continued (S4: YES), the processing returns to S1. When it is determined in the determination step S4 that this control is to be terminated (S4: NO), this control is terminated. The determination in the determination step S4 may be made, for example, by input from the user executing the method for controlling a lithium secondary battery. It may be automatically determined that the control is to be continued if no input is made by the user.

The method for controlling a lithium secondary battery according to the present embodiment is executed, for example, by a controller. The controller includes, for example, a processor such as a CPU, a storage device such as a read-only memory (ROM) and a random-access memory (RAM), a communication interface capable of communicating with the discharge controller and the restraint pressure controller, and a bus connecting these parts.

The specific configuration of the control unit of the discharge controller or the restraint pressure controller is not limited, and may be realized, for example, by a programmable logic controller (PLC) including an input unit that receives information from a sensor or the like, a processor such as a CPU, a power supply, and an output unit that transmits information to a relay or the like.

The preferred embodiment of the present invention has been described above. The present invention is not limited to the above embodiment, and modifications and improvements are included in the present invention to the extent that the object of the present invention can be achieved.

### EXPLANATION OF REFERENCE NUMERALS

1 battery cell (lithium secondary battery)
2 negative electrode
21 negative electrode active material layer (lithium metal layer, lithium metal alloy layer)
S1 dendrite detection step
S2 high-rate discharge step
S3 restraint pressure increasing step

What is claimed is:

1. A method for controlling a lithium secondary battery, the method comprising:
detecting presence or absence of dendrite deposition on a negative electrode of the lithium secondary battery;
performing high-rate discharge by a discharge controller for controlling a discharge amount of the lithium secondary battery when the dendrite deposition is detected; and
increasing a restraint pressure of the lithium secondary battery by a restraint pressure controller for controlling the restraint pressure of the lithium secondary battery after performing the high-rate discharge.

2. The method for controlling a lithium secondary battery according to claim 1, wherein a discharge rate of the high-rate discharge performed by the discharge controller when the dendrite deposition is detected is 1.0 C or more.

3. The method for controlling a lithium secondary battery according to claim 1, wherein the restraint pressure of the lithium secondary battery after being increased by the restraint pressure controller is 1.3 MPa or more.

4. The method for controlling a lithium secondary battery according to claim 1, wherein the negative electrode of the lithium secondary battery includes a lithium metal layer.
